(19) United States
(12) Patent Application Publication
(10) Pub. No.: US 2007/0102466 A1
(43) Pub. Date: May 10, 2007

(54) Vehicle having a roof rack

(75) Inventor: Wolfgang Kasch, Pinneberg (DE)

Correspondence Address: BROOKS KUSHMAN P.C., 1000 TOWN CENTER, TWENTY-SECOND FLOOR, SOUTHFIELD, MI, 48075, US

(73) Assignee: Magna Car Top Systems GmbH, Bietigheim-Bissingen (DE)

(21) Appl. No.: 11/548,879

(22) Filed: Oct. 12, 2006

(30) Foreign Application Priority Data
Oct. 12, 2005 (DE) 10 2005 049 358.0

(51) Int. Cl. B60R 9/00

(52) U.S. Cl. 224/400

(57) ABSTRACT

A roof rack for a vehicle includes a first support arm articulately connected to a first swivel joint fixable to the roof of a vehicle such that the first support arm is movable between a transverse position in which the first support arm is oriented in a transverse direction of the vehicle and a longitudinal position in which the first support arm is oriented in a longitudinal direction of the vehicle. The first support arm is lockable to a vehicle component while in its transverse position.

### CROSS-REFERENCE TO RELATED APPLICATIONS

This application claims foreign priority benefits under 35 U.S.C. § 119(a)-(d) to DE 10 2005 049 358.0, filed Oct. 12, 2005, which is hereby incorporated by reference in its entirety.

### BACKGROUND OF THE INVENTION

1. Field of the Invention

The present invention relates to a roof rack for a vehicle.

2. Background Art

A roof of a vehicle may include a pair of oppositely disposed, longitudinally extending roof railings (i.e., running in the longitudinal direction of the vehicle) for mounting a roof rack to the roof. Typically, a roof rack includes a pair of oppositely disposed, transversely extending support arms (i.e., running transverse to the longitudinal vehicle direction). Prior to using the roof rack to transport a load thereon, the ends of the support arms are mounted onto the roof railings such that the support arms extend transversely between the roof railings. The roof rack may then transport a load oriented in the longitudinal vehicle direction and fixed to the support arms. The support arms may be used to fix in place ski transport boxes or the like extending longitudinally beyond the support arms. A problem with such a roof rack is that it cannot be used spontaneously as it has to be mounted with effort on the roof and fixed in place prior to its use. That is, the support arms are transversely mounted to the roof railings regardless of whether or not the roof rack is transporting a load (i.e., the roof rack is permanently installed to the roof). Driving without a load on the roof rack increases fuel consumption as the transversely mounted support arms encounter wind resistance. Further, the roof rack may produce undesired noise without a load supported thereon.

### SUMMARY OF THE INVENTION

An object of the present invention is a roof rack for a vehicle in which the roof rack is an integral component of the vehicle, the roof rack may be used at any time, and the roof rack minimizes fuel consumption and road noise when a load is absent from the roof rack while the vehicle is being driven.

In carrying out the above object and other objects, the present invention provides a roof rack for a vehicle. The roof rack includes a first support arm articulately connected to a first swivel joint fixable to the roof of a vehicle such that the first support arm is movable between a transverse position in which the first support arm is oriented in a transverse direction of the vehicle and a longitudinal position in which the first support arm is oriented in a longitudinal direction of the vehicle. The first support arm is lockable to a vehicle component while in its transverse position. The first support arm is lockable to a vehicle component while in its longitudinal position.

The roof rack may further include a second support arm articulately connected to a second swivel joint fixable to the roof such that the second support arm is movable between a transverse position in which the second support arm is oriented in a transverse direction of the vehicle and a longitudinal position in which the second support arm is oriented in a longitudinal direction of the vehicle. The second support arm is lockable to a vehicle component while in its transverse position. The first and second support arms are separated from one another in their transverse and longitudinal positions and the first and second swivel joints are situated on opposite sides of the roof and separated at a distance from one another in the longitudinal direction of the vehicle. The length of at least one of the support arms may be variable.

The first support arm includes a fixed end and a free end. The fixed end of the first support arm is articulately connected to the first swivel joint. The free end of the first support arm is lockable to a vehicle component while the first support arm is in its transverse position. The second support arm includes a fixed end and a free end. The fixed end of the second support arm is articulately connected to the second swivel joint. The free end of the second support arm is lockable to a vehicle component while the second support arm is in its transverse position.

The roof rack may further include a pair of oppositely disposed first and second roof railings running longitudinally on opposite sides of the roof. The first swivel joint is fixable to the first roof railing such that the fixed end of the first support arm is articulately connected to the first roof railing. The second swivel joint is fixable to the second roof railing such that the fixed end of the second support arm is articulately connected to the second roof railing. The first support arm in its longitudinal position runs parallel to the first roof railing with the free end of the first support arm being lockable to the first roof railing to lock the first support arm against the first roof railing. The second support arm in its longitudinal position runs parallel to the second roof railing with the free end of the second support arm being lockable to the second roof railing to lock the second support arm against the second roof railing. Thee first support arm in its transverse position runs extends transversely between the first and second roof railings with the free arm of the first support arm being lockable to the second roof railing to lock the first support arm in its transverse position. The second support arm in its transverse position runs extends transversely between the first and second roof railings with the free arm of the second support arm being lockable to the first roof railing to lock the second support arm in its transverse position.

The first support arm and the first roof railing may be vertically movable relative to the roof between upper and lower positions while the first support arm is in its longitudinal position. The second support arm and the second roof railing may be vertically movable relative to the roof between upper and lower positions while the second support arm is in its longitudinal position. In this case, the first support arm in its lower position is lowered into a receiving opening for the first roof railing and the second support arm in its lower position is lowered into a receiving opening for the second roof railing.

The first support arm and the first roof railing may be vertically movable relative to the roof between upper and lower positions while the first support arm is in its longitudinal position. In the lower position the first support arm and the first roof railing are lowered into a first support arm receptacle in the roof. Likewise, the second support arm and the second roof railing may be vertically movable relative to the roof between upper and lower positions while the second support arm is in its longitudinal position. In the lower position the second support arm and the second roof railing are lowered into a second support arm receptacle in the roof. At least one first hydraulic lift cylinder may be attached to the first support arm receptacle for vertically moving the first support arm and the first roof railing between the upper and lower positions. At least one second hydraulic lift cylinder may be attached to the second support arm receptacle for vertically moving the second support arm and the second roof railing between the upper and lower positions. Alternatively, at least one first kinematic linkage is attached to the first support arm receptacle for vertically moving the first support arm and the first roof railing between the upper and lower positions; and at least one second kinematic linkage is attached to the second support arm receptacle for vertically moving the second support arm and the second roof railing between the upper and lower positions.

The roof rack may further include a first actuator for swiveling the first support arm between its transverse and longitudinal positions; and a second actuator for swiveling the second support arm between its transverse and longitudinal positions.

The roof rack may further include vertically extending first and second support legs respectively associated with the first and second support arms. The first support arm is coupled to a vehicle component via the first support leg and the second support arm is coupled to a vehicle component via the second support leg. The first support leg may be fixedly connected to a vehicle component and movable between an attached position in which the first support leg together with the first support arm is lockable and a stowed position; and the second support leg may be fixedly connected to a vehicle component and movable between an attached position in which the second support leg together with the second support arm is lockable and a stowed position. The first support leg may be fixedly connected to the first support arm and movable relative to the first support arm between an attached position in which the first support leg is lockable to a vehicle component and a stowed position; and the second support leg may be fixedly connected to the second support arm and movable relative to the second support arm between an attached position in which the second support leg is lockable to a vehicle component and a stowed position.

A roof rack in accordance with an embodiment of the present invention includes at least one support arm permanently connected to the roof of a vehicle. The support arm has a swivel capability by which the support arm is able to swivel about a fixed end between a transverse (loaded) position in which the support arm is oriented in the transverse direction of the vehicle and a longitudinal (empty load) position in which the support arm is oriented in the longitudinal direction of the vehicle. In the transverse position, a free end of the support arm may be locked to a vehicle component such as a roof railing thereby avoiding unintentional swivel motion of the support arm during vehicle travel. If the support arm is not needed for transporting a load, the support arm may be swivelled from the transverse position to the longitudinal position. In the longitudinal position, the support arm runs longitudinally along a side region of the roof. In the longitudinal position, the air resistance of the support arm is reduced compared to the transverse position as the narrow side of the support arm points in the direction of vehicle travel. This minimizes fuel consumption and road noise. As the support arm is an integral component of the vehicle and need only be swivelled from the longitudinal position to the transverse position for use of the roof rack, the roof rack may be used spontaneously.

In an embodiment of the present invention, secure locking of the free end of the support arm while the support arm is in the longitudinal direction is provided such that the support arm may be used to accept loads while in the longitudinal position. In this case, for many applications it is not necessary to swivel the support arm into the transverse position.

An advantage of a roof rack in accordance with the present invention is that storage space such as in a garage or basement is economized for storing the roof rack outside of the vehicle.

In an embodiment of the present invention, the roof rack includes a pair of spaced apart support arms. First and second swivel joints are respectively associated with the first and second support arms. The first support arm swivels about the first swivel joint between transverse and longitudinal positions. Likewise, the second support arm swivels about the second swivel joint between transverse and longitudinal positions. The swivel joints are situated in opposite side regions of the vehicle roof. The first swivel joint is in the front region of the roof along one side region of the roof and the second swivel joint is in the rear region of the roof along the opposite side region of the roof such that the two swivel joints are separated from one another in both the transverse and longitudinal directions of the vehicle. This ensures that the first support arm is situated in its transverse position in the front region of the roof and the second support arm is situated in its transverse position, at a longitudinal distance from the first support arm, in the rear region of the roof, thereby enabling a load to be fixed to both support arms in the longitudinal direction.

In an embodiment of the present invention, to ensure that the support arms have sufficient vertical clearance from the roof, the support arms are linked to, or on, respective roof railings (longitudinal struts) running in the longitudinal direction of the vehicle on opposite sides of the roof.

In an embodiment of the present invention, to secure the support arms against swivelling from their longitudinal positions, the support arms in their longitudinal positions run parallel to respective roof railings (longitudinal struts) and are respectively lockable to the roof railings.

In an embodiment of the present invention, to further minimize road noise and fuel consumption, each support arm is movable between upper and lower vertical positions while in either their transverse or longitudinal positions. In particular, each support arm together with its roof railing (longitudinal strut) is movable between the upper and lower positions. The air resistance of the support arm (and the associated roof railing) in the lower vertical position is less than the air resistance of the support arm (and the associated roof railing) in the upper vertical position. The roof rack is advantageously designed such that the support arm in its longitudinal position is movable between the upper and lower vertical positions, and the support arm is moved into the upper vertical position prior to the swivel motion of the support arm from its longitudinal position toward its transverse position.

In an embodiment of the present invention, each support arm may be lowered into a receiving opening or swivelled from the side into the receiving opening. When a support arm is lowered or swivelled into a receiving opening, the air resistance of the support arm is significantly reduced.

In an embodiment of the present invention, each support arm together with its associated roof railing (longitudinal strut) may be lowered into a support arm receptacle on or in the roof. In its longitudinal position, the support arm may be lowered together with its associated roof railing into the receptacle. The support arm and its associated roof railing are no longer visible after being completely lowered into the receptacle. This embodiment is suited for use in high-end sedans as the appearance of the vehicles is not adversely affected when the support arm is lowered.

In an embodiment of the present invention, each support arm may be articulately connected to an associated support leg instead of being articulately connected to an associated roof railing. The support arm together with the associated support leg may be lowered into a support arm receptacle on or in the roof. In this embodiment as well, the esthetic appearance of the vehicle is not impaired when the support arm is lowered.

The support arm receptacles may be located, at least in part, underneath the roof and concealed by interior vehicle trim.

In an embodiment of the present invention, at least one hydraulic lift cylinder attached to a vehicle component such as the roof or a support arm receptacle actuates to move a support arm, preferably together with its associated longitudinal strut (e.g., roof railing, support leg, and the like), between upper and lower vertical positions. In an embodiment of the present invention, two hydraulic lift cylinders are provided for each support arm and are situated in opposite end regions of the support arm. The support arm may be lowered, for example into a support arm receptacle, by use of the hydraulic lift cylinders. The support arm together with a swivel joint may be attached directly to a hydraulic lift cylinder. In this case, the hydraulic lift cylinders assume the vertical support function, and if needed may replace a longitudinal strut, associated with the support arm, running in the longitudinal direction of the vehicle.

The hydraulic lift cylinders may be provided below the longitudinal strut associated with a support arm. In this case, the hydraulic cylinders raise or lower the support arm together with its associated longitudinal strut between upper and lower vertical positions. An additional or alternative possibility for lowering the support arm, preferably together with its associated longitudinal strut, into a support arm receptacle includes the use of a kinematic linkage mechanism such as a four-bar kinematic linkage. The four-bar kinematic linkage includes a pair of guide rods. The lower ends of the guide rods are fixedly linked to a support arm receptacle. The upper ends of the guide rods are articulately connected to the support arm or, alternatively, to the longitudinal strut associated with the support arm. The support arm together with a swivel joint may be attached to a guide rod of the kinematic linkage mechanism. In an embodiment, no drive is provided for the kinematic linkage mechanism as the support arm is manually adjusted with the assistance of an elastic force between its lower and upper vertical positions.

In an embodiment of the present invention, an actuator acting directly on the kinematic linkage mechanism swivels a support arm between its upper and lower vertical positions. Examples of actuators include electric motors, hydraulic lift cylinders, and drives having gear racks, gearwheels, rollers, linear and magnetic guides, and cables. Additionally or alternatively, an actuator may be provided for swiveling the support arm between the transverse position and the longitudinal position.

Additionally or alternatively to the roof railing associated with a support arm, a first vertically extending support leg may be associated with the support arm. Via the first support leg, the support arm is connected either to the roof railing or to another vehicle component such as the roof. In an embodiment of the present invention, the support arm is swivelably connected to the first support leg, or the first support leg is swivelably linked to the vehicle component. A second support leg fixes the support arm to the oppositely situated roof railing or to a vehicle component such as the roof. The support legs provide a sufficient vertical clearance from the roof such that the support arm may be swivelled between its transverse position and its longitudinal position. In an embodiment of the present invention, the support arm together with the first support leg may be moved between upper and lower vertical positions. In the lower vertical position, the support arm together with the first support leg is lowered into a support arm receptacle in the roof.

The second support leg, which is not articulately connected to the support arm, is fixedly connected to a vehicle component such as the roof and may be moved between an attached position, in which the second support leg together with the support arm is lockable, and a stowed position, for example a lowered position.

Alternatively, the support leg provided on the end of the support arm opposite from the swivel joint may be fixedly connected to the support arm by a swivel joint, for example, so that the support leg may be swivelled out from its vertical position, thereby enabling the support arm to swivel between its transverse position and its longitudinal position. In the transverse position of the support arm, the support leg is moved in its attached position and is locked to a vehicle component such as the roof.

To enable each support arm to simultaneously swivel without colliding, the length of at least one of the support arms is changeable. The support arm may, for example, be telescopically extended. Another possibility is that a section of the support arm is foldable so that the length of the support arm may be varied.

The roof rack may be used for multi-part movable roof designs. In this case the hydraulic lift units as well as the attachment points of the longitudinal and transverse struts are matched to the various positions of the roof parts in the motion sequence. The various locations of drives, guides, gears, and locks on the particular roof regions or positions may be distributed or provided according to functional criteria and the esthetic appearance of the vehicle.

The above features, and other features and advantages of the present invention are readily apparent from the following detailed descriptions thereof when taken in connection with the accompanying drawings.

### BRIEF DESCRIPTION OF THE DRAWINGS

FIG. 1 illustrates a schematic of a roof rack in accordance with an embodiment of the present invention;

FIG. 2 illustrates a support arm and its associated roof railing and support arm receptacle of a roof rack in accordance with an embodiment of the present invention; and

FIG. 3 illustrates a roof rack in accordance with another embodiment of the present invention.

### DETAILED DESCRIPTION OF THE PREFERRED EMBODIMENT(S)

Identical components have the same reference numerals in the Figures.

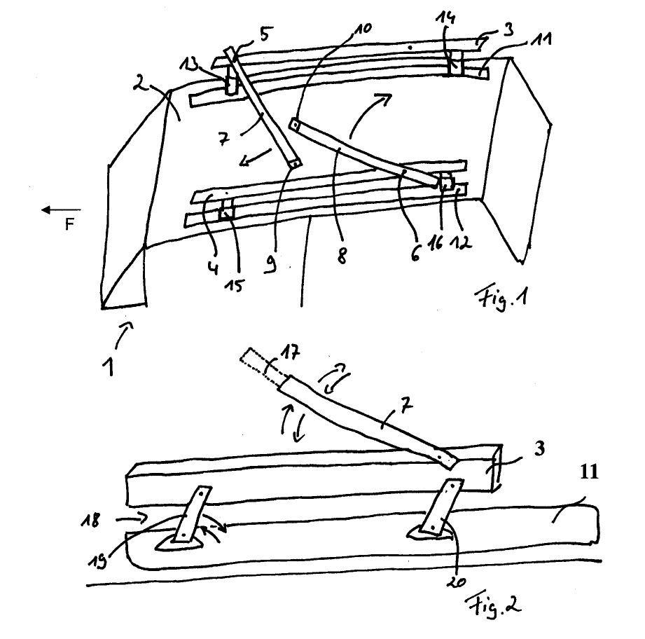

Referring now to FIG. 1, a roof rack for a vehicle 1 having a roof 2 in accordance with an embodiment of the present invention is shown. Arrow “F” indicates the forward direction of travel of vehicle 1. Roof 2 includes first and second roof railings 3, 4 (i.e., longitudinal struts). Roof railings 3, 4 are oppositely disposed from one another on side regions of roof 2. Roof railings 3, 4 run in the longitudinal direction of vehicle 1. As such, roof railings 3, 4 are longitudinally extending roof railings. First roof railing 3 runs longitudinally along the right-hand side region of roof 2 and second roof railing 4 runs longitudinally along the left-hand side of roof 2. As such, roof railings 3, 4 run parallel to one another and are separated by a transverse distance from one another.

The roof rack includes a pair of support arms 7, 8. A first swivel joint 5 articulately connects the fixed end of first support arm 7 to first roof railing 3. First support arm 7 may swivel about first swivel joint 5 between a transverse position in which first support arm 7 is oriented transversely between roof railings 3, 4 and a longitudinal position in which first support arm 7 is oriented longitudinally along (i.e., runs parallel to) first roof railing 3. Likewise, a second swivel joint 6 articulately connects the fixed end of second support arm 8 to second roof railing 4. Second support arm 8 may swivel about second swivel joint 6 between a transverse position in which second support arm 8 is oriented transversely between roof railings 3, 4 and a longitudinal position in which second support arm 8 is oriented longitudinally along (i.e., runs parallel to) second roof railing 4. In FIG. 1, support arms 7, 8 are illustrated in respective intermediate positions between their transverse and longitudinal positions.

In its longitudinal position, first support arm 7 is located on top of first roof railing 3. Free end 9 of first support arm 7 may be locked to first roof railing 3 when first support arm 7 is in its longitudinal position in order to prevent unintentional swivelling of first support arm 7 about first swivel joint 5. Likewise, in its longitudinal position, second support arm 8 is located on top of second roof railing 4. Free end 10 of second support arm 8 may be locked to second roof railing 4 when second roof railing 4 is in its longitudinal position in order to prevent unintentional swivelling of second support arm 8 about second swivel joint 6.

In its transverse position, first support arm 7 runs in the transverse direction of vehicle 1 roughly at a 90° angle with respect to roof railings 3, 4 and transversely extends between roof railings 3, 4. Free end 9 of first support arm 7 may be locked to second roof railing 4 to thereby lock first support arm 7 in its transverse position. Likewise, in its transverse position, second support arm 8 runs in the transverse direction of vehicle 1 roughly at a 90° angle with respect to roof railings 3, 4 and transversely extends between roof railings 3, 4. Free end 10 of second support arm 8 may be locked to first roof railing 3 to thereby lock second support arm 8 in its transverse position. In their transverse positions, support arms 7, 8 of the roof rack are capable of bearing a load.

When support arms 7, 8 are in their longitudinal positions and locked to the associated roof railings 3, 4, support arms 7, 8 together with their associated roof railings 3, 4 may be lowered into respective support arm receptacles 11, 12 located below roof 2. As such, support arms 7, 8 together with their associated roof railings 3, 4 are vertically movable with respect to roof 2 between a lower position in which they are lowered into respective support arm receptacles 11, 12 of roof 2 and an upper position. To achieve this vertical movement, a first pair of hydraulic lift cylinders 13, 14 fixed inside first support arm receptacle 11 is provided for first support arm 7. Likewise, a second pair of hydraulic lift cylinders 15, 16 fixed inside second support arm receptacle 12 is provided for second support arm 8. First and second support arm receptacles 11, 12 are advantageously matched to respective first and second support arms 7, 8 in such a way that in the lower position support arms 7, 8 close off support arm receptacles 11, 12 flush with roof 2.

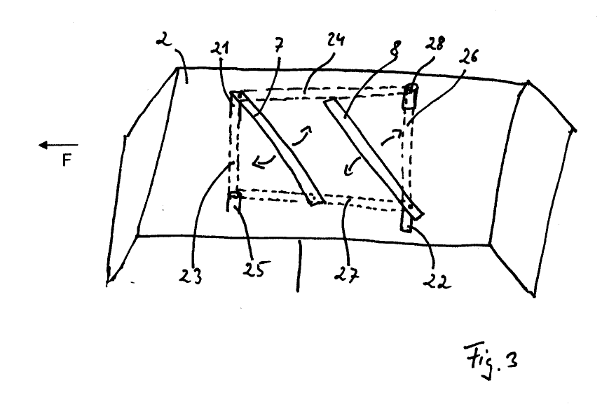

Referring now to FIG. 2, with continual reference to FIG. 1, first support arm 7 and its associated roof railing 3 and first support arm receptacle 11 are shown. The description with reference to FIG. 2 is of first support arm 7. However, the description of second support arm 8 is the same. As described above and as shown in FIG. 2, first support arm 7 is linked at its fixed end to first roof railing 3 located along one side region of roof 2. First support arm 7 may be telescopically extended by a first support arm section 17. In this manner a collision with second support arm 8 is avoided during the swivel motion between the transverse position and the longitudinal position.

A four-bar kinematic linkage 18 having two spaced-apart guide rods 19, 20 connected to roof railing 3 enables roof railing 3 together with first support arm 7 to swivel into first support arm receptacle 11. The lower ends of guide rods 19, 20 are inside first support arm receptacle 11 and connected to the first support arm receptacle 11. The upper ends of guide rods 19, 20 are connected to roof railing 3. Roof railing 3 (together with first support arm 7) may accordingly be lowered in a rotational-translational motion from an upper position to a lower position inside first support arm receptacle 11. In this embodiment, no actuator is provided for an automated motion of roof railing 3 as the adjustment is made manually.

Referring now to FIG. 3, with continual reference to FIGS. 1 and 2, a roof rack in accordance with another embodiment of the present invention is shown. In this embodiment, the roof rack includes first and second support legs 21, 22 which are fixedly connected to respective side regions of roof 2. The fixed end of first support arm 7 of the roof rack is articulately linked to first support leg 21. First support arm 7 may swivel about its articulated connection to first support leg 21 between a transverse position 23 (illustrated in dashed lines) and a longitudinal position 24 (also illustrated in dashed lines). In its transverse position 23, first support arm 7 may be locked to a first vertical support leg 25 which is fixedly connected to the side region of roof 2 opposite from first support leg 21.

Similarly, the fixed end of second support arm 8 of the roof rack is articulately linked to second support leg 22. Second support arm 8 may swivel about its articulated connection to second support leg 22 between a transverse position 26 (illustrated in dashed lines) and a longitudinal position 27 (illustrated in dashed lines). In its transverse position 26, support arm 8 may be locked to a second vertical support leg 28 which is fixedly connected to the side region of roof 2 opposite from second support leg 22.

Support arms 7, 8 together with their associated support legs 21, 22, 25, 28 may be lowerable into respective support arm receptacles provided in roof 2.

### LIST OF REFERENCE NUMERALS

1 Vehicle
2 Roof
3 First roof railing
4 Second roof railing
5 First swivel joint
6 Second swivel joint
7 First support arm
8 Second support arm
9 Free end
10 Free end
11 First support arm receptacle
12 Second support arm receptacle
13 Hydraulic lift cylinder
14 Hydraulic lift cylinder
15 Hydraulic lift cylinder
16 Hydraulic lift cylinder
17 Support arm section
18 Four-bar kinematic linkage
19 Guide rod
20 Guide rod
21 First support leg
22 Second support leg
23 Transverse position
24 Longitudinal position
25 First vertical support leg
26 Transverse position
27 Longitudinal position
28 Second vertical support leg
F Forward direction of vehicle travel

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A roof rack for a vehicle, the roof rack comprising:
a first support arm articulately connected to a first swivel joint fixable to the roof of a vehicle such that the first support arm is movable between a transverse position in which the first support arm is oriented in a transverse direction of the vehicle and a longitudinal position in which the first support arm is oriented in a longitudinal direction of the vehicle, wherein the first support arm is lockable to a vehicle component while in its transverse position.

2. The roof rack of claim 1 wherein:
the first support arm is lockable to a vehicle component while in its longitudinal position.

3. The roof rack of claim 1 further comprising:
a second support arm articulately connected to a second swivel joint fixable to the roof such that the second support arm is movable between a transverse position in which the second support arm is oriented in a transverse direction of the vehicle and a longitudinal position in which the second support arm is oriented in a longitudinal direction of the vehicle, wherein the second support arm is lockable to a vehicle component while in its transverse position;
wherein the first and second support arms are separated from one another in their transverse and longitudinal positions and the first and second swivel joints are situated on opposite sides of the roof and separated at a distance from one another in the longitudinal direction of the vehicle.

4. The roof rack of claim 3 wherein:
the first support arm includes a fixed end and a free end, wherein the fixed end of the first support arm is articulately connected to the first swivel joint, wherein the free end of the first support arm is lockable to a vehicle component while the first support arm is in its transverse position;
wherein the second support arm includes a fixed end and a free end, wherein the fixed end of the second support arm is articulately connected to the second swivel joint, wherein the free end of the second support arm is lockable to a vehicle component while the second support arm is in its transverse position.

5. The roof rack of claim 4 further comprising:
a pair of oppositely disposed first and second roof railings running longitudinally on opposite sides of the roof;
wherein the first swivel joint is fixable to the first roof railing such that the fixed end of the first support arm is articulately connected to the first roof railing;
wherein the second swivel joint is fixable to the second roof railing such that the fixed end of the second support arm is articulately connected to the second roof railing.

6. The roof rack of claim 5 wherein:
the first support arm in its longitudinal position runs parallel to the first roof railing with the free end of the first support arm being lockable to the first roof railing to lock the first support arm against the first roof railing;
wherein the second support arm in its longitudinal position runs parallel to the second roof railing with the free end of the second support arm being lockable to the second roof railing to lock the second support arm against the second roof railing.

7. The roof rack of claim 6 wherein:
the first support arm in its transverse position runs extends transversely between the first and second roof railings with the free arm of the first support arm being lockable to the second roof railing to lock the first support arm in its transverse position;
wherein the second support arm in its transverse position runs extends transversely between the first and second roof railings with the free arm of the second support arm being lockable to the first roof railing to lock the second support arm in its transverse position.

8. The roof rack of claim 7 wherein:
the first support arm and the first roof railing are vertically movable relative to the roof between upper and lower positions while the first support arm is in its longitudinal position;
wherein the second support arm and the second roof railing are vertically movable relative to the roof between upper and lower positions while the second support arm is in its longitudinal position.

9. The roof rack of claim 8 wherein:
the first support arm in its lower position is lowered into a receiving opening for the first roof railing;
the second support arm in its lower position is lowered into a receiving opening for the second roof railing.

10. The roof rack of claim 7 wherein:
the first support arm and the first roof railing are vertically movable relative to the roof between upper and lower positions while the first support arm is in its longitudinal position, wherein in the lower position the first support arm and the first roof railing are lowered into a first support arm receptacle in the roof;
wherein the second support arm and the second roof railing are vertically movable relative to the roof between upper and lower positions while the second support arm is in its longitudinal position, wherein in the lower position the second support arm and the second roof railing are lowered into a second support arm receptacle in the roof.

11. The roof rack of claim 10 further comprising:
at least one first hydraulic lift cylinder attached to the first support arm receptacle for vertically moving the first support arm and the first roof railing between the upper and lower positions;
at least one second hydraulic lift cylinder attached to the second support arm receptacle for vertically moving the second support arm and the second roof railing between the upper and lower positions.

12. The roof rack of claim 10 further comprising:
at least one first kinematic linkage attached to the first support arm receptacle for vertically moving the first support arm and the first roof railing between the upper and lower positions;
at least one second kinematic linkage attached to the second support arm receptacle for vertically moving the second support arm and the second roof railing between the upper and lower positions.

13. The roof rack of claim 3 further comprising:
a first actuator for swiveling the first support arm between its transverse and longitudinal positions; and
a second actuator for swiveling the second support arm between its transverse and longitudinal positions.

14. The roof rack of claim 3 further comprising:
a vertically extending first support leg associated with the first support arm, wherein the first support arm is coupled to a vehicle component via the first support leg;
a vertically extending second support leg associated with the second support arm, wherein the second support arm is coupled to a vehicle component via the second support leg.

15. The roof rack of claim 14 wherein:
the first support leg is fixedly connected to a vehicle component and is movable between an attached position in which the first support leg together with the first support arm is lockable and a stowed position;
wherein the second support leg is fixedly connected to a vehicle component and is movable between an attached position in which the second support leg together with the second support arm is lockable and a stowed position.

16. The roof rack of claim 14 wherein:
the first support leg is fixedly connected to the first support arm and is movable relative to the first support arm between an attached position in which the first support leg is lockable to a vehicle component and a stowed position;
the second support leg is fixedly connected to the second support arm and is movable relative to the second support arm between an attached position in which the second support leg is lockable to a vehicle component and a stowed position.

17. The roof rack of claim 3 wherein:
the length of at least one of the support arms is variable.
